(19) United States
(12) Patent Application Publication
(10) Pub. No.: US 2026/0222169 A1
(43) Pub. Date: Jul. 30, 2026

(54) ENHANCED RESTART OF NODES AFTER INTERRUPTION

(71) Applicant: Net Insight AB, Solna (SE)

(72) Inventor: Paul DREIK, Nacka (SE)

(73) Assignee: Net Insight AB, Solna (SE)

(21) Appl. No.: 19/146,314

(22) PCT Filed: Jan. 29, 2024
(86) PCT No.: PCT/EP2024/052064

§ 371 Date: Jul. 8, 2025

(30) Foreign Application Priority Data
Jan. 31, 2023 (SE) 2350091-1

(51) Int. Cl. H04L 7/00

(52) U.S. Cl. CPC H04L 7/0016; H04L 7/0008

(57) ABSTRACT

The current disclosure relates to methods for resuming a time of a clock in a first node after interruption of service, and systems for performing the methods. A second node may keep the time during downtime of the first node, and transmit sync pulses to the first node, which may be used for estimating a time error that may be used to adjust the clock of the first node.

### TECHNICAL FIELD

The present disclosure relates to methods for restarting a node in a communication system that require time synchronization. More specifically, the present disclosure relates to methods for resuming a time of a clock in a node after interruption of service, and systems for performing the methods.

### BACKGROUND

Nodes that communicate with other nodes in a network need to be synchronized for efficient communication e.g., by keeping an internal clock synchronized to internal clocks of other nodes. This may be achieved by different synchronization or time transfer processes. Nodes sometimes need to be temporarily shut down or restarted, for instance when upgrading. After the upgrade, the internal clock will have been interrupted and be out of sync, and a time transfer or synchronization process will need to be repeated to resume the clock. It may take in the order of 1000 seconds(s) before the node sync is stable and the node can deliver time again. During this period, performance of the node will be impaired. Accordingly, methods and systems for enhanced synchronization of nodes after downtime is needed.

### SUMMARY

An object of the present disclosure is to provide methods and systems which seek to mitigate, alleviate, or eliminate the above-identified deficiencies in the art and disadvantages singly or in any combination. This object is obtained by a method for resuming a local clock, e.g., resuming a time including a time count of a local clock, of a first node in a system after an interruption of service of the first node, the system comprising a memory, a second node and one or more frequency oscillator, each oscillator being in connection with one or both of the first and second node.

According to an aspect, the method optionally comprises continuously receiving, in the first and second node, an oscillator signal from one of the one or more oscillator, wherein the oscillator signal is used for maintaining local clocks in the first and second node. The method further comprises receiving, in the first node from the second node, a first sync pulse, obtaining, in the first node, first data related to the first sync pulse, timestamping, in the first node, the received first sync pulse with a timestamp t1 relating to a time when the first sync pulse was received in relation to the local clock in the first node, storing, in the memory of the system, the timestamped first sync pulse and the obtained first data, interrupting service of the first node, and restarting the service of the first node.

In an aspect, restarting the service of the first node comprises retrieving, in the first node, information from the memory, the information comprising the first sync pulse and its timestamp, t1, and the obtained first data, receiving, in the first node from the second node, a second sync pulse, obtaining, in the first node, second data related to the second sync pulse, wherein the first and second data enables the first node to estimate a time that has passed between a second sync pulse and a first sync pulse, timestamping, in the first node, the received second sync pulse with a timestamp t2 relating to a time when the sync pulse was received in relation to the local clock in the first node, estimating, in the first node, based on the retrieved information, the timestamp t2 of the second sync pulse and the second data, a time error, E, of the local clock of the first node, and adjusting the internal clock of the first node using the estimated time error to resume the time of the local clock.

In an embodiment, the method comprises, after timestamping the received second sync pulse, evaluating, in the first node, based the retrieved information and the second data, if a synchronization of the local clock of the first node based on the second sync pulse and second data is possible; and on condition that synchronization based on information relating to the second sync pulse is not possible, resuming the internal clock of the first node using a regular clock recovery process, such as a regular time transfer or synchronization process from an external system.

According to some aspects, the disclosure further comprises a system for enabling resumption of a local clock in a first node after interruption of service of the first node, the system comprising: a first node comprising a local clock, a communication interface, which may comprise a transceiver, and processing circuitry, a second node comprising a local clock, a communication interface, which may comprise a transceiver, and processing circuitry, one or more frequency oscillator, each of the one or more oscillator being in connection with one or both of the first and second node, and a memory, wherein the system is configured to carry out the methods described above and below.

Other objects and advantages will become apparent to those skilled in the art from a review of the ensuing detailed description, which proceeds with reference to the following illustrative drawings, and the attendant claims.

Generally, all terms used in the claims are to be interpreted according to their ordinary meaning in the technical field, unless explicitly defined otherwise herein. Further, the use of terms “first”, “second”, and “third”, and the like, herein do not denote any order, quantity, or importance, but rather are used to distinguish one element from another. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present inventive concept, will be better understood through the following illustrative and non-limiting detailed description of different embodiments of the present inventive concept, with reference to the appended drawings, wherein:

FIG. 1 illustrates an embodiment of the present invention including a system comprising a first node, a second node, and a first and a second oscillator, and a memory.

FIG. 2 illustrates an embodiment of the present invention where an external approximate source of time is used for approximating the time error for adjusting the time of the clock C1.

FIG. 3 illustrates an embodiment of the present invention, where metadata related to the sync pulses is used for approximating the time error for adjusting the time of the clock C1.

FIG. 4 illustrates an embodiment where one single oscillator provides an oscillator signal to both the first and the second node.

FIG. 5 illustrates an example of an embodiment where the clock rate of the first node is controlled.

FIG. 6 illustrates an example of a system according to a specific embodiment.

FIG. 7 illustrates an example of a system according to a generic embodiment.

FIG. 8 is a block diagram illustrating a first node according to an embodiment.

FIG. 9 is a block diagram illustrating a second node according to an embodiment.

FIG. 10 is a flowchart of a method of resuming the time of a local clock of a first node according to an embodiment.

FIG. 11 is a flowchart of a method of restarting the first node and resuming the time of a local clock of the first node according to an embodiment.

The FIGURES are not necessarily to scale, and generally only show parts that are necessary in order to elucidate the inventive concept, wherein other parts may be omitted or merely suggested.

### DETAILED DESCRIPTION

Aspects of the present disclosure will be described more fully hereinafter with reference to the accompanying drawings. The system and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some embodiments a non-limiting term “node” or “network node” is used. It should be understood that this term refers to any type of node that may send and/or receive information, such as data and control information, over a network. A physical node is typically an electronic device that is attached to a network, and is capable of creating, receiving, or transmitting information over a communications channel. The node may be a data communication equipment (DCE) such as a modem, hub, bridge, router or switch, or data terminal equipment (DTE) such as a digital telephone handset, a printer, a server, or a host computer. It may refer to an integrated circuit (IC), such as a field-programmable gate array (FPGA) or an application-specific integrated circuit (ASIC). In an example, the node may be a computer terminal connected to a network, such as a local area network (LAN), wide area network (WAN) or the Internet. In another example, a node may be synchronization equipment, such as a boundary clock or grandmaster connected to the network.

The term “network” refers to any type of network over which a network node may communicate, such as a local area network (LAN), wide area network (WAN) or the Internet. The network may use different network technologies such as Ethernet, SDH, SONET, PDH, ATM, DTM or IP. The network may be referred to as an Internet Protocol (IP) network, a communication network that uses IP to send and receive messages between one or more nodes or computers, which may be implemented in Internet networks, WAN, LAN and enterprise networks, for example. The service network may be used for mobile networks such as 2G/3G/4G/5G/6G networks, power networks, fintech network, or single frequency networks (SFN) or a media network including digital television (DTV) or a digital radio distribution network.

The term “reset” in the context of resetting a node or system, refers to any type of restart, readjustment or restoring to a desired value. It includes rebooting of the node or system. The term “reboot” in the context of rebooting a node or system refers to a restart of the node or system, typically including to shut down and restart the node or system. To reboot is to reload the operating system of a computer, i.e., to start it up again. Booting is starting a computer's operating system, so rebooting is to start it for a second or third time.

The term “interruption” as in “interruption of service” of a node refers to an event which temporarily shuts down normal operation of the node, such as communication with other nodes and also internal features of the node, such as the processor, memory and local clock, resulting in a downtime of the node. A “downtime” refers to a time during which a machine, e.g., a computer, is out of action or unavailable for use. While downtime is the time when a node/system is not operational, uptime is the time during which it is operational.

A network node is a connection point in a communications network, such as a computer network. A node may refer to a basic unit of a data structure, such as a linked list or tree data structure, where the nodes contain data and also may link to other nodes, and May often be arranged into tree structures. Each node is an endpoint for data transmissions or redistribution. Nodes have either a programmed or engineered capability to recognize, process and forward transmissions to other network nodes. Examples of nodes include bridges, switches, hubs, and modems to other computers, printers, servers, client and peers. One of the most common forms of a node is a host computer; often referred to as an Internet node. In telecommunications, node-to-node data transfer is the movement of data from one node of a network to the next. In the OSI model it is handled by the lowest two layers, the data link layer and the physical layer.

Bipolar junction transistors, diodes and field effect transistors are commonly used electronics component in electronic circuit. These components are interconnected along with required resistors and capacitors to form an electronic circuit. This type of circuit is known as discrete circuit as each of the components can be separated from the circuit when required. It has become common to produce electronic circuit where on a semiconductor wafer number of diodes, transistors, and capacitors are permanently fabricated, referred to as an integrated circuit (IC), as the components in this type of electronic circuit are not separable but is integrated on the semiconductor wafer. IC is also popularly known as chip or microchip.

Thus, integrated circuits (also referred to as an IC, a chip, or a microchip), are a set of electronic circuits on one small flat piece (or “chip”) of semiconductor material, usually silicon. ICs are semiconductor wafers with millions of tiny resistors, capacitors, and other components. ICs can be used for a variety of purposes including amplifiers, video processors, computer memory, switches, and microprocessors.

Examples of integrated circuits include field-programmable gate arrays (FPGAs) and application-specific integrated circuits (ASICs). A basic FPGA architecture consists of thousands of fundamental elements called configurable logic blocks (CLBs) surrounded by a system of programmable interconnects, called a fabric, that routes signals between CLBs. Input/output (I/O) blocks interface between the FPGA and external devices. Depending on the manufacturer, the CLB may also be referred to as a logic block (LB), a logic element (LE) or a logic cell (LC). Higher-function FPGAs include functional blocks dedicated to specific functions, such as clock management components, phase-locked loops (PLLs), high-speed serializers and deserializers, Ethernet MACs, PCI express controllers and high-speed transceivers. FPGAs are used in telecommunications and networking, but also in consumer, automotive, and industrial applications.

FPGAs employ the use of several blocks or flip flops that work in parallel in different interconnecting paths that can be operated in different frequencies. Clocks are what make it possible for the various flip flops inside a single FPGA to transition to a new state at the clock speed, allowing FPGA to make high speed calculation or bit manipulation in high speed. A clock is a signal inside any digital circuit that determines how fast a flip flop (or a group of flip flops) runs. The clock signal is connected to all flip flops and RAM blocks and activates them according to the clock frequency. The faster the clock, the faster the design will run and therefore a higher clock speed FPGA will perform any desired function quicker than a slow clock speed FPGA. A typical FPGA consists of several clock signals and thus allows different areas across the FPGA to operate at different speeds. A single FPGA system will employ the use of at least one clock that will generate a wave at a certain frequency which will then be distributed across the FPGA to produce a synchronized response from all the flip flops involved in the design. An external oscillator placed on the circuit board is that which generates the square wave or clock signal with a certain frequency and enters the FPGA system through a single physical connecting pin. The clock signals are distributed along interconnected lines or wires called global routing or global lines so that the signal is distributed and received at the same time by each flip flop. If the signal reaches the different flip flops at different times, the time difference between the reception of the clock pulse is called skew and can interfere with the performance of the system.

A single clock domain may be used to generate multiple frequencies of waves and run different components using the PLL (Phase Locked Loop) of the FPGA. The Phase Locked Loop takes the reference clock and spins it up to generate a very high frequency in Giga Hertz in accordance with the clock required for the equipment, i.e., it is possible to manipulate the code to change how often the clock enabler gets pulsed and thus determine the frequency of the resultant signal waves. Instead of having a dedicated clock for everything, use a clock that has a certain wave frequency, e.g., 50 MHz, and then have it to pulse regularly (every so often per number of cycles) to get a customized clock with variable frequencies.

There are many circumstances in which it is desired to generate new clock signals and efficiently distribute them throughout a system, for which FGPAs use dedicated clock management blocks. Clock management blocks can generate new clock signals by performing clock multiplication and division, and may be able to apply a programmable phase shift to a generated clock or even adjust the duty cycle of a clock. They can de-skew not only the clock signals distributed within the FPGA but also the clocks distributed out of the FPGA to other devices on and FPGA board. One application for the programmable phase shift feature is synchronizing the clock signal with input data.

The local clock of the first node may be absolute, i.e., corresponding to the current wall-clock, time-of-day time, the time that a regular clock would show at a time instance at that certain place in the world. Instead of an absolute clock, a monotonic clock may be used in the first node. A monotonic clock is a time source that will never jump forward or backward (due to NTP or Daylight Savings Time updates, etc.). A monotonic time represents the absolute elapsed wall-clock time since some arbitrary, fixed point in the past, and is not affected by changes in the system time-of-day clock, where time is usually reported as the number of units (usually microseconds or nanoseconds) since some arbitrary instant. A monotonic clock monotonically increases as time progresses. For example, a monotonic clock in an FPGA has a monotonic time, whose rate is numerically controlled and that starts at zero when the FPGA starts. Thus, a monotonic clock comprises a counter which counts the time from a previous instant to the present time, and resuming a monotonic clock involves resuming the clock at a count where it would have been if it had not been interrupted. For example, if the local clock of the first node is a monotonic clock, by knowing the number of sync pulses that has passed during the downtime, and the time between each sync pulse (pulse interval), the time that has passed during the downtime may be calculated, and the clock time may be restored, and the clock resumed at the correct time.

In a classical context, the term synchronization (or just synch) means adjustment of rhythms of self-sustained periodic oscillators due to their weak interaction, which adjustment can be described in terms of phase locking and frequency entrainment. Phase synchronization is the process by which two or more cyclic signals tend to oscillate with a repeating sequence of relative phase angles. Phase synchronization is usually applied to two waveforms of the same frequency with identical phase angles with each cycle. Synchronization measurements may include phase measurements in view of reference signals, phase deviation and analysis of the phase time interval error, fractional frequency offset, maximum time interval error (MTIE) and time deviation (TDEV). The time of the local clocks of the nodes in the present disclosure are typically maintained by using oscillator signals continuously received from one of the oscillators (may be the same or different). These oscillator signals may also be referred to as output or output signals.

Nodes that communicate with other nodes in a network need synchronization for efficient communication, such as a distributed clock. Time transfer in a network, such as for network synchronization (synchronization between nodes in a network), is essential for the function of a network. For example, many networks, such as packet based networks, require frequency and time synchronization (phase alignment) between nodes for successful operation and packet transfer, and many applications and services require the network to distribute accurate time and frequency to their nodes, such as mobile base stations, radio and TV transmitters, sensors, etc., operators may also provide synchronization services to their customers for use in their applications in for example servers or machines, or in self-driving cars. Synchronization in distributed systems is achieved via clocks. The physical clocks are used to adjust the time of nodes. Each node in the system can share its local time with other nodes in the system. The task of network synchronization is to distribute a reference signal from the primary reference clock (PRC) to all network elements requiring synchronization. The method used for propagating the reference signal in the network is usually the master-slave method, a.k.a. controller-responder, primary-replica, and leader-follower methods, a hierarchical model where the slave or responder clock must be slaved to (must respond to) a clock of higher (or equal) stability. Synchronization information is transmitted through the network via synchronization network connections. Synchronization network connections typically are unidirectional and generally point-to-multipoint. A centralized timing network architecture may be used, or a distributed timing network architecture (e.g., using Global Navigation Satellite System, GNSS).

Time (relative and absolute) and frequency transfer describes mechanisms for comparing measurements of time and frequency from one location to another. Time transfer is a scheme where multiple sites share a precise reference time. Multiple techniques have been developed, often transferring reference clock synchronization from one point to another, often over long distances. Time transfer may be used for time synchronization between different entities or nodes in a network, which is essential for the function of the network. Packet based frequency distribution from a reference clock to a recovered clock comprises the steps generation from signal to packet, transfer including packet transmission over packet network, recovery from packet to signal.

Techniques for time synchronization of network nodes without utilization of GPS includes, for example, the network time protocol (NTP), which may be used to synchronize the clocks of network nodes to a master node or a reference clock using time stamps. The Precision Time Protocol (PTP) is a protocol used to synchronize clocks throughout a computer network, also known as IEEE 1588. IEEE 1588-2019 includes a profile concept, a.k.a. default profile or standard profile, defining PTP operating parameters and options. Several profiles have been defined for applications including telecommunications, electric power distribution and audiovisual. The earlier IEEE 1588-2008 introduced a clock associated with network equipment used to convey PTP messages. There are five basic types of PTP devices (“clocks”); ordinary clock (master or slave), boundary clock (“master and slave”), end-to-end transparent clock, peer-to-peer transparent clock and management node. All five types implement one or more aspects of the PTP protocol. The transparent clock modifies PTP messages as they pass through the device. Timestamps in the messages are corrected for time spent traversing the network equipment. This scheme improves distribution accuracy by compensating for delivery variability across the network. PTP messages may use the User Datagram Protocol over Internet Protocol (UDP/IP) for transport.

In certain instances, a node will be unavailable, and will not receive any oscillator signals or synchronization messages. When a node is shut down or temporarily unavailable, such as restarted e.g., due to being upgraded, the node will have to start the time recovery or synchronization process from scratch, and typically it may take in the order of 1000 s before the node sync is stable and the node can deliver time again. During this start up the functioning of the node or system will be impaired. Thus, there is an object of the present disclosure to minimize the time it takes for the node or system to resume a correct time after an interruption, such as a reset or reboot.

Accordingly are provided enhanced methods for resuming a time of a local clock after an interruption of service, such as a reset or reboot, where the node time is kept in a secondary node during the reboot. This resuming includes correcting the clock in accordance with an estimated time error. This resuming of a correct time, or maintaining of the clock, may in some cases be seen as synchronization or “resynchronization” of a node. In an example, the operation of a first FPGA, such as a main FPGA, is interrupted, e.g., due to a reset or a reboot, and it will need clock recovery after the interruption to return to service. Instead of performing a clock recovery or synchronization from scratch, which takes a long time, the node time is kept in a secondary node, such as a secondary FPGA, during the interruption. E.g., during a reboot, the secondary FPGA keeps the node time while the rest of the system reboots. When the main FPGA comes back into service, it resumes keeping the node time.

This means the local clock or node sync will effectively go into holdover, but the clock and node sync will be unavailable during the reboot. After the reboot it will however resume much quicker than a full (cold) boot. For example, a (the) length of the holdover may be in the order of 100 s (depending on the oscillator performance), which may be acceptable for the end user (for example, a 5G base station).

Thus, the present disclosure enables a time of a local clock of a first node to be resumed after an interruption of service, i.e., maintained as if non downtime would have passed, by adjusting the time after restart according to an approximated time error. The clock may be monotonic or absolute, and the time error may be approximated differently depending on the type of clock.

As an example, we are running a clock, which is monotonic or absolute, and which may be kept aligned with some external time or frequency, for instance by using time transfer. For some reason the service of the first node is interrupted, for example the clock needs to be restarted, or perhaps it was forced to restart due to a power outage. We need to recover operation when the clock has been started again. If the clock is monotonic, it would need to restore the count from when it was last running. The naive approach of storing the clock value before reboot, then starting at that value when it comes back up again would lead to a time error equal to how long the downtime was. This could be seconds, minutes or more, which is unacceptable for many applications. If the clock is absolute and uses time transfer, reestablishing the time using regular time transfer has drawbacks. The reason is that time transfer takes some time to establish and converge, which will lead to longer time than necessary for the clock to be unavailable. It is valuable to have as short downtime as possible. It is thus the aim of the present disclosure to recover operation, resume a time of a local clock in a node, with no more error than what the natural frequency drift of the oscillator causes during the outage. Typically, a high-quality oscillator can drift 0.1 ppb during a 100 second reboot. Thus, the error introduced by the reboot would be less than 10 ns.

Thus, in the setting for the methods of the current disclosure, a first node receives, continuously, an oscillator signal from one of one or more oscillator, where the time of the local clock of the first node may be kept based on said oscillator signal, and wherein execution of the first node may be clocked by the one oscillator. A second node, correspondingly, also continuously receives an oscillator signal from one of one or more oscillator, where the time of a local clock of the second node may be kept based on said oscillator signal. The oscillators may be the same, i.e., the first and the second node receive oscillator signals from the same oscillator, or they may be different, such that the first and the second node receive oscillator signals from two different oscillators.

The first and the second node, and the one or more oscillator, are present in a system. A sync pulse is transmitted from the second node to the first node. The sync pulse can be irregularly transmitted, be transmitted upon request or repeatedly transmitted at a constant interval, referred to as a sync pulse interval or just pulse interval. The frequency of such repeatedly transmitted sync pulses may be low, such as having a pulse interval of seconds or minutes, depending on the application, hence much lower than the frequency of the continuously transmitted oscillator pulses. The frequency of the sync pulses may also be higher, such as 1 million pulses per second. The first node is aware of the pulse interval, it may either be stored in a memory in the system for retrieval by the first node, or it may be sent from the second node to the first node, in the sync pulse or in a separate transmission. Thus, the first node will obtain information regarding the pulse interval, pᵢᵥ, e.g. by retrieval from a memory or by receiving said information. Each sync pulse will be timestamped in the first node, with a timestamp relating to a time when the sync pulse was received in relation to the local clock in the first node. Thus, when the first node is in service and its local clock is running, then the time between two timestamps should equal the pulse interval. However, when the service of the first node is interrupted, the timestamp of the last sync pulse received before the interruption (first sync pulse), and the first sync pulse received after the interruption (second sync pulse) will be longer, and the clock will have to be adjusted accordingly to resume a correct time.

Each sync pulse will have data related to it, which is obtained in the first node. This data may be sent in the same transmission as the sync pulse, or be separate from said transmission, such as sent in a separate transmission. The timestamps of the received sync pulses, and their related data, may be stored in a memory in the system, where the memory may be within the first node, or located elsewhere in the system. Thus, the first node will store the last received sync pulse before interruption of service (first sync pulse) and its related data (first data) in a memory, which information may then be retrieved upon restart. Thus, after the interruption when the first node and its local clock is restarting, the first node will receive a sync pulse (second sync pulse). The perceived elapsed time in the first node may be obtained by using the timestamped sync pulses, but the time that has actually passed in the second node is more difficult to determine. This may be performed in different ways as indicated below.

If the local clock of the first node keeps a monotonic time, then the data will comprise so called metadata, d, which comprises information of a sync pulse count for each respective sync pulse. Thus, the metadata enables the first node to determine which pulse count the present sync pulse has, and may thus using two such metadata determine how many pulses that has passed between the two pulses. Optionally, the data will also comprise the pulse interval, pᵢᵥ, or it may be obtained otherwise by the first node. Hence, it may be possible to determine a time error, for adjusting the local clock in the first node, between a sync pulse received before an interruption of service, and one received after, based on said metadata and the timestamps of the respective sync pulses. The time error for adjusting the local clock to resume a time of the local clock of the first node may thus be calculated as E=e2−e1, where E is the time error. e1 is the apparent elapsed time in the first node, i.e. the time that have passed between the two sync pulses in the first node, which is determined/calculated based on the timestamps, t1 for the first sync pulse received before the interruption, and t2 for the second sync pulse received after the interruption, where e1=t2−t1. e2 is the apparent elapsed time in the second node, i.e., the pulse count that have passed between the two sync pulses in the second node, which is determined/calculated based on the metadata (sync pulse count for each respective sync pulse), d1 being the metadata for the first sync pulse received before the interruption, and d2 being the metadata for the second sync pulse received after the interruption, where e2=(d2−d1)*pᵢᵥ, where pᵢᵥ is the pulse interval.

If the local clock of the first node keeps an absolute time, then the data will comprise an approximate absolute time, a, relating to an approximate absolute time when the first or second sync pulse, respectively, was received in the first node. Optionally, it will also comprise the pulse interval, pᵢᵥ, or it may be obtained otherwise by the first node. Hence, it may be possible to determine a time error, for adjusting the local clock in the first node, between a sync pulse received before an interruption of service, and one received after, based on said data and the timestamps of the respective sync pulses. The time error for adjusting the local clock to resume a time of the local clock of the first node may thus be calculated as E=e2−e1, where E is the time error. e1 is the apparent elapsed time in the first node, i.e. the time that have passed between the two sync pulses in the first node, which is determined based on the timestamps, t1 for the first sync pulse received before the interruption, and t2 for the second sync pulse received after the interruption, where e1=t2−t1. e2 is the apparent elapsed time in the second node, i.e. the absolute time that have passed between the two sync pulses in the second node, which is determined/calculated based on the data, approximate absolute time, a, for the respective sync pulses, a1 being the approximate time for transmission of the first sync pulse received in the first node before the interruption, and a2 being the approximate time for transmission of for the second sync pulse received in the first node after the interruption, i.e. a2-a1, where the pulse interval may be used for rounding off e2 to the nearest multiple of the interval length pᵢᵥ giving e2=round (a2-a1, pᵢᵥ).

In the methods of the invention, at least two sync pulses are needed, one before the interruption, and one after. As long as the timestamps and related data is known, a time error may be determined. In some embodiments, the second node transmits sync pulses repeatedly before the interruption of service, where one sync pulse before the interruption, typically the last received sync pulse may be used as a first sync pulse in the time error estimations. In another embodiment, the information relating to several sync pulses before the interruption is used, and averaged, for a better estimation.

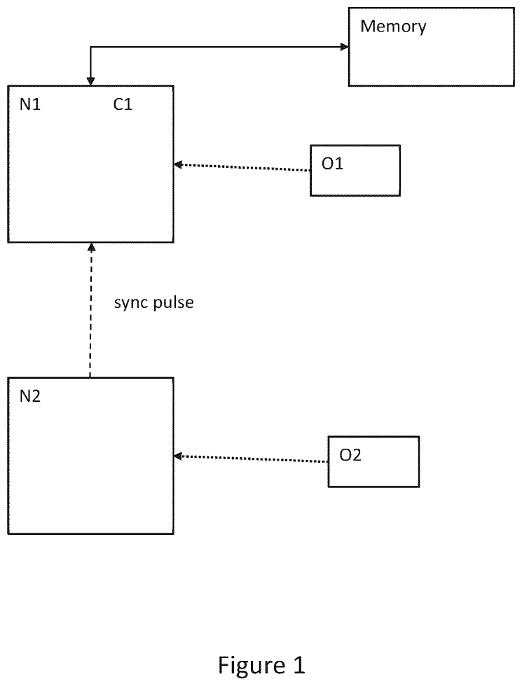

FIG. 1 illustrates an embodiment of the present invention, a system comprising a first node, N1, having a local clock, C1, a second node, N2, a first oscillator, O1, providing an oscillator signal to the first node, a second oscillator, O2, providing an oscillator signal to the second node, and a memory in connection with the first node. A sync pulse is sent repeatedly from the second node to the first node during normal operation. In this case, C1 is the clock we want to be able to restart. N2 is a supplementary system. N2 may be connected to N1 or separate. It is vital that N2 does not go down/restart while N1 restarts. If it does, it must somehow be detected so N1 knows it cannot trust the data from it. The sync pulse from N2 is timestamped by N1. Before restart(ing), N1 remembers the last sync pulse and stores it in the memory. After restart, N1 reads back the timestamp for the last stored sync pulse. It waits for the next sync pulse from N2, and timestamps it. It can now compensate its own clock C1 so the elapsed time between the stored and current timestamp is equal to the elapsed time on N2. This compensation/adjustment will be performed differently depending on the type of time that C1 keeps, as described above.

In the simplest case, the sync pulse has no external information. If it is setup to happen with a fixed time interval, say 10 seconds, the elapsed time will be known up to a multiple of 10 seconds. This ambiguity can be solved in a plethora of ways.

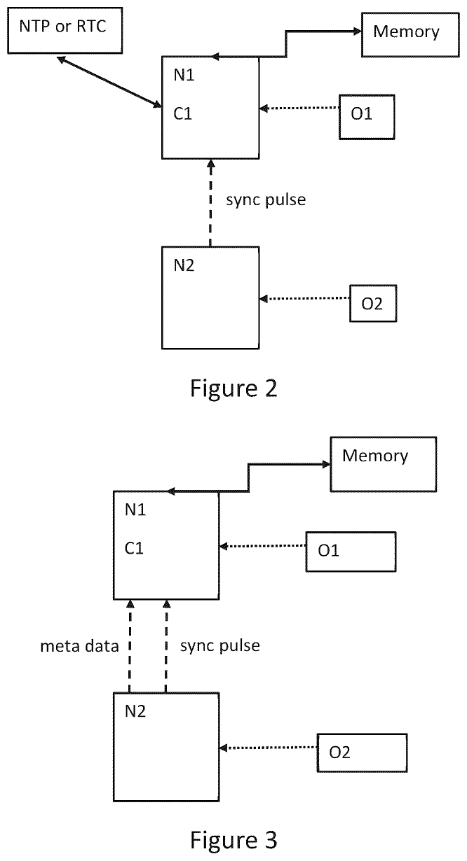

FIG. 2 illustrates an embodiment of the present invention in a similar system as FIG. 1. In this embodiment, an external approximate source of time is used for approximating the time error for adjusting the time of the clock C1. N1 can query some external source which does not need to be accurate compared to the sync pulses from N2. For instance, an NTP server can be used, or a battery backed RTC (real time clock) clock. The difference of the approximate time, a, when the sync pulse before and after restart were received, can be rounded to a multiple of the sync pulse interval, which information may be previously known to N1 (such as using a fixed interval of 10 s), or may be retrieved from a memory or sent to N1 from N2. The estimated time error may then be calculated as E=e2−e1, where e2 is based on a2-a1 rounded off using pᵢᵥ, as described above.

FIG. 3 illustrates an embodiment of the present invention in a similar system as FIG. 1. In this embodiment, metadata, d, related to the sync pulses is used for approximating the time error for adjusting the time of the clock C1. If N2 can signal metadata related to the sync pulse, disambiguation can be made without an external source. For instance, a pulse count can be used which can be signaled externally through some data channel from N2 to N1. It is also possible to encode the pulse count into the sync pulse as a pulse train. The leading edge is the sync pulse, and the rest of the pulse train encodes a message which contains the pulse count. Encoding the signal into the sync pulse itself makes it possible to have a very short interval between the sync pulses, which makes it possible to do the restart quicker. The estimated time error may then be calculated as E=e2−e1, where e2 is d2−d1, as described above.

The basic principle for the above-mentioned embodiments may thus be summarized in the following steps: 1. N1 stores the timestamp t1 when a sync pulse from N2 arrives along with metadata d1 about the sync pulse or approximate time a1. This is stored in the external (or internal) memory. 2. N1 restarts. 3. N1 waits for the next sync pulse from N2. 4. N1 stores the timestamp t2 for the sync pulse, along with metadata d2 or approximate time a2. 5. The apparent elapsed time on N1 is e1=t2−t1. 6. The apparent elapsed time e2 on N2 is determined from, d1 and d2, or a1 and a2; i) if pulse count is used: e2=pulse count difference times the pulse interval length, d2−d1*pᵢᵥ, ii) if NTP is used, round the difference in NTP time at a1 and a2 to the nearest multiple of the interval length, e2=rounded off (rounded up or down) approximate time difference times, a2−a1, i.e., e2=round (a2-a1, pᵢᵥ). Compensate the time at N1, adjust clock C1 to resume accurate time of C1, by stepping the time e2-e1. This is the basic principle. In practice, one can improve the accuracy by using more than two pulses and using an estimate of the frequency error of the oscillator(s). Thus, by averaging over several pulses, a more accurate result may be attained.

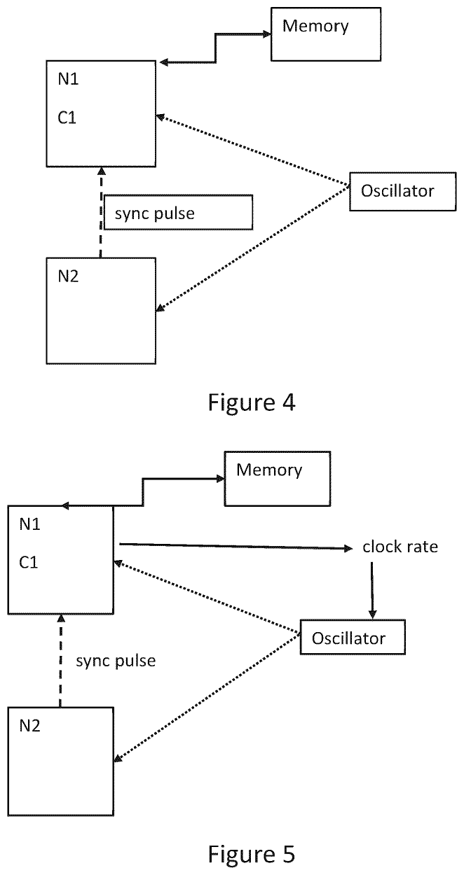

In the above examples, the first and the second node receives oscillator signals from different oscillators. However, it is also possible to use only one and same oscillator. As illustrated in FIG. 4, in an embodiment the system comprises a first node N1, a second node N2, a memory and one oscillator, which provides an oscillator signal to both N1 and N2. This reduces costs. Also, N1 may benefit from having a better model of the drift of the oscillator, which can be used to refine the estimate of the elapsed time on N2.

For the time error correction to work, the time/operation of N2 must have been kept during the downtime of the N1. Thus, for the recovery to work, N2 must not have an interruption of service/restart while N1 restarts. That could be the case if there for instance is a power outage. There are several possible ways of detecting that also N2 has experienced a downtime. One way to detect this is if N2 selects a random token at each startup and passes it along with the metadata channel with every sync pulse. N1 stores the token along with the timestamp. If N2 has experienced a downtime, it will thus select a new token upon restarting. N1 can check the token of the first pulse received after restart and if it matches the stored token (before restart of the first node), be certain that N2 has not restarted.

In a further embodiment, as illustrated in FIG. 5, the clock rate of N1 is controlled. This is the case if N1 uses time transfer and is in frequency and/or time sync with some external system. All oscillators have errors and drift. It is possible that N1 uses its estimate of frequency error of the oscillator to improve the accuracy of the estimate of elapsed time on N2. The clock C1 in N1 can be numeric and controlled, while the external oscillator is fixed. Another possibility is that the oscillator is frequency steered. Both cases have the possibility to adjust for the frequency error while estimating the elapsed time on N2.

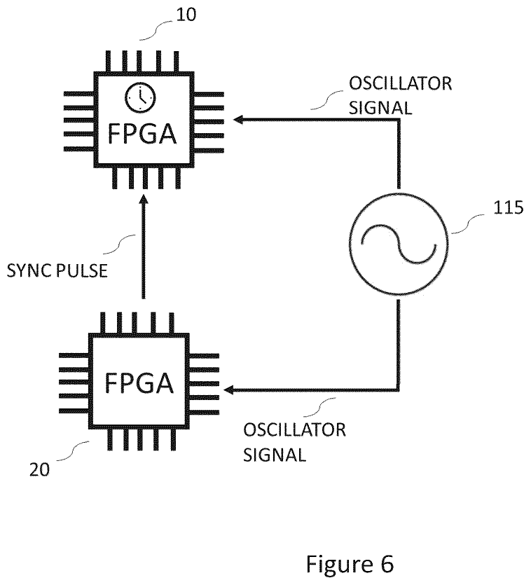

In some embodiments is provided a system according to FIG. 6, for resuming a time of a local clock after interruption of service. The system comprises a first node (10), a main FPGA having a local clock, a second node (20), a secondary FPGA, transmitting a sync pulse to the first node, an oscillator (115) sending an oscillator signal to the first and the second node.

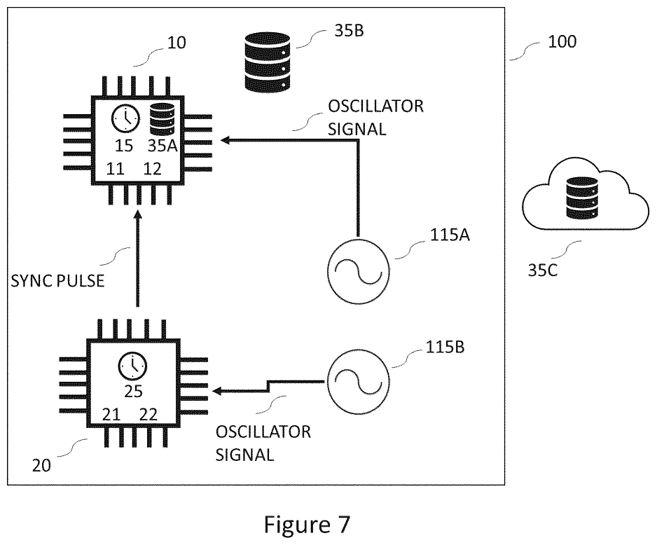

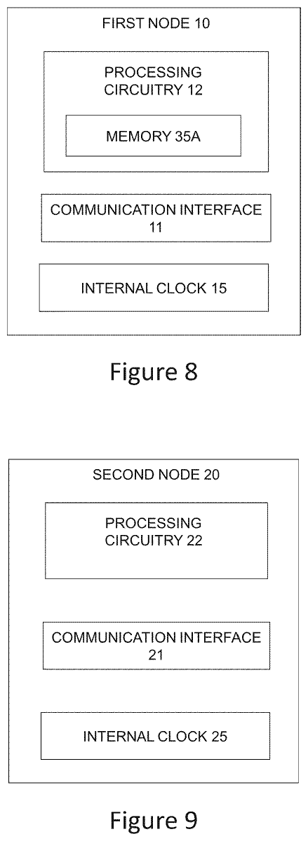

In another embodiment illustrated in FIG. 7 is provided a system (100) for enabling resumption of a time of a local clock (15) in a first node (10) after interruption of service of the first node, the system comprising: a first node (10) comprising a local clock (15), a communication interface (11) and processing circuitry (12); a second node (20), comprising a local clock (25), a communication interface (21) and processing circuitry (22); one or more frequency oscillator (115A,B), each of the one or more oscillator (115A, B) being in connection with one or both of the first (10) and second node (20); a memory (35A,B,C), wherein the memory can be part for the first node (35A), separate from the first node but within the system (35B) or outside the system, for example in a cloud (35C); wherein the system is configured to carry out the methods above and below. Block diagrams of the respective first and second nodes are depicted in FIGS. 8 and 9, where the first node (10) comprises a local clock (15), a communication interface (11) and processing circuitry (12), and optionally a memory (35A), and the second node (20) comprises a local clock (25), a communication interface (21) and processing circuitry (22).

System requirements (hardware requirements) include a connection from the oscillator to both nodes, and a connection from the second node to the first node, on which the sync pulse is carried. In some aspects, for the firmware of the first node, which may also be referred to as the main FPGA, it should timestamp the sync pulse with a timestamp t, just like it timestamps for instance PPS (pulse per second) in with t. For the firmware of the second node, which may also be referred to as a secondary FPGA, at boot, the sync output should be disabled. Thus, the first and second node may comprise a first and second FPGA, respectively, which may be referred to as the main FPGA and the secondary FPGA. There should be no spurious sync pulses during boot. It shall be possible to set the value of N within reasonable bounds.

In some aspects, the system comprises: i) a fixed frequency oscillator, which is assumed to be turned on during the entire restart/reboot, ii) a first node, such as a main FPGA, whose execution is clocked by the oscillator, and a numeric clock in the main FPGA, which has a monotonic time, whose rate is numerically controlled (say within +−10 ppm), which starts at zero when the FPGA starts, iii) a second node, such as a secondary FPGA, connected to the oscillator, it may or may not also be clocked by the oscillator, iv) a connection between the two FPGAs such that the secondary FPGA can signal the main FPGA by raising an output and the main FPGA can accurately capture the time with timestamps t, v) a controlling process (the “sync application”), which besides calculating the control signal for the numeric clock, it also keeps a clock offset, which summed with t gives the absolute time when the node is in sync, vi) a memory for persistent storage of data. The sync application may be run by processing circuitry in the first node.

Upon restart, the main FPGA and the sync application, time count will start from zero again. It is then possible to use NTP, or another absolute time capable mechanism, to get an approximately correct time offset. When a sync pulse comes in, the absolute time for it is attained by using tgi (which is precise) and the offset (which is approximate at this point).

In an actual implementation, the sync pulse would be observed using the same mechanism as estimating frequency inputs. This smooths out discretization errors. After restart/reboot, the control signal is set to a sane value (the estimated frequency error, with opposite sign). This reduces the impact of observations/control signals delay. The sync pulse is observed for a few values to smooth out discretization errors. It will temporarily be considered an absolute time source just like PPS in, but with adjustments because the frequency oscillator error must be compensated for.

The present disclosure relates to the case when only the first node (and not the second node) of the system restarts. For a complete reboot, or a cold start of the system, where also the second node experiences downtime, the time cannot be kept. At least the oscillator and the second node need to be running uninterrupted during the restart. In case the second node needs to be updated and rebooted, it can do so from the sync application point of view. The first node will keep on ticking. The sync pulse between the two nodes is only used during the restart of the first node. Thus, the present disclosure relates to methods for enhanced restart of nodes after interruption. The interruption of service of the first node may be sudden and unscheduled, or it may be planned. Thus, in an embodiment, the first node indicates to higher layers that it is ready for restart, before the system interrupts its service and restarts it. In this case, the sync pulse transmissions may start just before the planned downtime.

In some embodiments, the sync application will be aware of the restart, and establish that necessary conditions are in place, such as that the node time is stable, the absolute time (or pulse count) is known, and the uncertainty in the estimate of the oscillator drift model is sufficiently low to trust it. The sync application may instruct the second node (secondary FPGA) to output a pulse to the first node (main FPGA) every N:th clock cycle of the oscillator. N may be chosen big enough to be able to properly distinguish pulses from each other. N is chosen small to minimize waiting time and to be able to average out the sampling discretization error (FPGA action happens at clock cycles). A reasonable value of N would give something like a 1 Hz pulse. The main FPGA sends observations of the sync pulse timestamped with tgi to the memory, related to the sync application. When the sync application is happy with the observations, it stores its state in persistent storage, including uncertainty of absolute time, estimated oscillator drift parameters (at a minimum: current frequency error), the phase of the sync pulse, as tgi+tgoffs. The sync application then signals to higher layers that it is ready to reboot itself and the main FPGA. The main FPGA restarts and the sync application is started by higher layers of control, such as system or similar. This includes for example, i) the main FPGA staring a count, it will start counting tgi at zero, ii) the control signal for the numeric clock will be zero iii) the sync application reads from the memory (persistent storage) and finds out it possibly has data to carry out the enhanced restart iv) given that the secondary FPGA has not rebooted, it will still send sync pulses to the main FPGA, which are noted by the main FPGA and sent as observations to the sync application, v) the sync application queries the secondary FPGA for the pulse count or by using coarse time from NTP, vi) the sync application uses the stored information together with the recent sync pulse observations to find out if everything is in place to resume the time (for instance, the enhanced restart/reboot time must be within a reasonable limit and the sync pulse observations must be within reasonable bounds), and if not, a normal restart/boot happens instead, vii) an initial state for the control is calculated using a combination of the stored information and the recent sync pulse observations, where the most important parts of the state are the clock signal and tgoffs, where the control is set off using these values, viii) when the initial control has converged (essentially treating the sync pulse as an absolute time source) the sync application can switch to normal control.

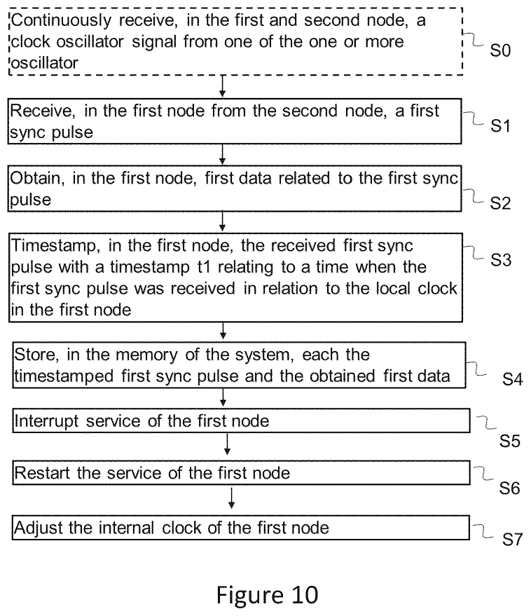

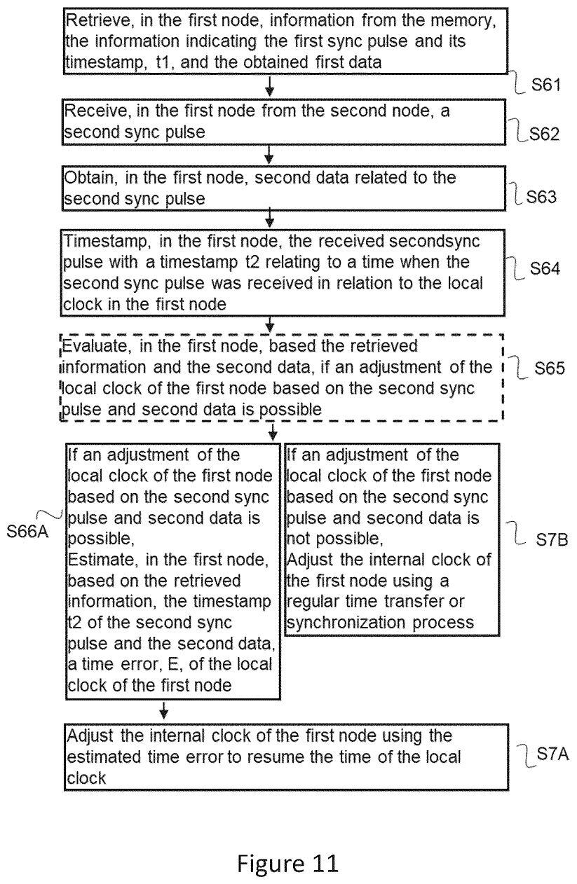

The proposed methods will now be described in more detail referring to FIGS. 10 and 11. It should be appreciated that FIGS. 10 and 11 comprise some operations and modules which are illustrated with a solid border and some operations and modules which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations do not need to be performed in order. Furthermore, it should be appreciated that not all of the operations need to be performed.

FIG. 10 illustrates a method for resuming a time of a local clock of a first node in a system after an interruption of service of the first node, the system comprising a memory, a second node and one or more frequency oscillator, each oscillator being in connection with one or both of the first and second node, the method comprising: optionally continuously receiving (S0), in the first and second node, an oscillator signal from one of the one or more oscillator, wherein the clock oscillator signal is used for maintaining local clocks in the first and second node; and wherein the oscillator signals received in the first and second node, respectively, are from a same frequency oscillator or from different frequency oscillators. The method further comprises receiving (S1), in the first node from the second node, a first sync pulse; obtaining (S2), in the first node, first data related to the first sync pulse; timestamping (S3), in the first node, the received first sync pulse with a timestamp t1 relating to a time when the first sync pulse was received in relation to the local clock in the first node; storing (S4), in the memory of the system, the timestamped first sync pulse and the obtained first data; interrupting (S5) service of the first node; restarting (S6) the service of the first node, and adjusting (S7) the internal clock of the first node using the estimated time error to resume the time of the local clock.

In some embodiments, the sync pulse is repeatedly transmitted/received with a certain pulse interval, and the method comprises: repeatedly receiving (S1), in the first node from the second node, a first sync pulse; repeatedly obtaining (S2), in the first node, first data related to the first sync pulse; timestamping (S3), in the first node, each received first sync pulse with a timestamp t1 relating to a time when a respective first sync pulse was received in relation to the local clock in the first node; and storing (S4), in the memory of the system, each timestamped first sync pulse and the obtained first data.

FIG. 11 illustrates a method restarting (S6) the service of the first node in the method above, wherein the restarting comprises: retrieving (S61), in the first node, information from the memory, the information indicating the first sync pulse and its timestamp, t1, and the obtained first data; receiving (S62), in the first node from the second node, a second sync pulse; obtaining (S63), in the first node, second data related to the second sync pulse, wherein the first and second data enables the first node to estimate a time that has passed between a second sync pulse and a first sync pulse; timestamping (S64), in the first node, the received second sync pulse with a timestamp t2 relating to a time when the sync pulse was received in relation to the local clock in the first node; optionally evaluating (S65), in the first node, based the retrieved information and the second data, if an adjustment of the time of the local clock of the first node based on the second sync pulse and second data is possible; and on condition that adjustment of a time of the local clock based on information relating to the second sync pulse is not possible; adjusting (S7B) the internal clock of the first node using a regular time transfer or synchronization process. In some embodiments, this evaluation may be done using tokens, wherein the first and second data comprises a first and second random token, which token is selected anew every time the second node restarts, and wherein evaluating (S65), if an adjustment synchronization of the local clock of the first node based on the second sync pulse and second data is possible comprises: comparing the first random token to the second random token; and on condition that the first random token and the second random token are identical, determining that adjustment of the local clock of the first node based on the second sync pulse and second data is possible; or on condition that the first random token and the second random token are not identical, determining that adjustment of the local clock of the first node based on the second sync pulse and second data is not possible. The presence of a new token indicates that the second node has also restarted, and thus that the time given by its sync pulses cannot be trusted. If adjustment of a time of the local clock based on information relating to the second sync pulse is possible, or not evaluated, the method further comprises estimating (S66A), in the first node, based on the retrieved information, the timestamp t2 of the second sync pulse and the second data, a time error, E, of the local clock of the first node; and adjusting (S7A) the internal clock of the first node using the estimated time error to resume the time of the local clock.

In some embodiments, obtaining (S2) first data related to the first sync pulse comprises: obtaining first data comprising first metadata, d1, for the first sync pulse from the second node, and obtaining a pulse interval, pᵢᵥ, relating to a time interval between two consecutive sync pulses, wherein said pulse interval may be obtained from the second node, or from a memory, and; wherein obtaining (S63) second data related to the second sync pulse comprises: obtaining, second data comprising second metadata, d2, for the second sync pulse from the second node, wherein the first and second metadata comprises information of the sync pulse count for each respective sync pulse. In this embodiment, estimating (S66A) a time error, E, of the local clock of the first node comprises: estimating (S66A) the time error, E, as e2−e1, wherein e1 is the apparent elapsed time in the first node determined based on the timestamps as e1=t2−t1, and e2 is the apparent elapsed time in the second node determined based on the metadata and the pulse interval as e2=(d2−d1)*pᵢᵥ, wherein t1 is the timestamp and d1 is the metadata of the received first sync pulse before interruption of service of the first node, and t2 is the timestamp and d2 is the metadata of the received second sync pulse after restart of service of the first node.

In another embodiment, obtaining (S2) first data related to the first sync pulse comprises: obtaining first data comprising an approximate absolute time, a1, relating to an approximate absolute time when the first sync pulse was received in the first node, and optionally a pulse interval, pᵢᵥ, relating to a time interval between two consecutive sync pulses, and; wherein obtaining (S63) second data related to the first sync pulse comprises: obtaining, second data comprising an approximate absolute time, a2, relating to an approximate absolute time when the second sync pulse was received in the first node. In this embodiment, estimating (S66A) a time error, E, of the local clock of the first node comprises:

estimating the time error, E, as e2−e1, wherein e1 is the apparent elapsed time in the first node determined based on the timestamps as e1=t2−t1, and e2 is the apparent elapsed time in the second node determined based on the approximate absolute time as e2=a2−a1 rounded off using pᵢᵥ, wherein t1 is the timestamp and a1 is the approximate absolute time of the received first sync pulse before interruption of service of the first node and t2 is the timestamp and a2 is the approximate absolute time of the received second sync pulse after restart of service of the first node, and wherein e2 is rounded off to the closest multiple (integer) or the pulse interval pᵢᵥ. The approximate absolute time may be obtained from any available source, such as from a battery backed real time clock, RTC, or a network time protocol, NTP, server. Calling a server using e.g., a http protocol will give a response including a coarse timestamp. Any source that may give an indication of the time, of a reasonable accuracy depending on the application, may be used.

In the embodiments described above, obtaining (S2, S63) first or second data includes receiving a separate transmission comprising the first or second data, or receiving the first or second data within each sync pulse transmission from the second node, for example by encoding the pulse count into the sync pulse as a pulse train.

The interruption of service may be due to a reset, restart or reboot of the first node, which may be planned, such as for an upgrade of the system, or unplanned e.g., due to a power outage, or similar. In some embodiments, the first node is a field-programmable gate array (FPGA). The second node may also be a field-programmable gate array (FPGA), wherein the first node is a main FPGA, and the second node is a secondary FPGA.

The content of this disclosure thus enables enhanced restart of a first node after interruption of service, when the first node is part of a system comprising a secondary node, which is not restarting and which is thus able to keep the time for the first node during downtime.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, products, and systems. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be realized in the broadest sense of the claims.

1. A method for resuming a time of a local clock of a first node in a system after an interruption of service of the first node, the system comprising a memory, a second node and one or more frequency oscillator, each oscillator being in connection with one or both of the first and second node, the method comprising:
receiving, in the first node from the second node, a first sync pulse;
obtaining, in the first node, first data related to the first sync pulse;
timestamping, in the first node, the received first sync pulse with a timestamp t1 relating to a time when the first sync pulse was received in relation to the local clock in the first node;
storing, in the memory of the system, the timestamped first sync pulse
and the obtained first data;
interrupting service of the first node;
restarting the service of the first node, the restarting comprising:
retrieving, in the first node, information from the memory, the information indicating the first sync pulse and its timestamp, t1, and
the obtained first data;
receiving, in the first node from the second node, a second sync pulse;
obtaining, in the first node, second data related to the second sync pulse, wherein the first and second data enables the first node to estimate a time that has passed between a second sync pulse and a first sync pulse;
timestamping, in the first node, the received second sync pulse with a timestamp t2 relating to a time when the sync pulse was received in relation to the local clock in the first node;
estimating, in the first node, based on the retrieved information, the timestamp t2 of the second sync pulse and the second data, a time error, E, of the local clock of the first node; and
adjusting the internal clock of the first node using the estimated time error to resume the time of the local clock.

2. The method of claim 1, the method further comprising:
continuously receiving, in the first and second node, an oscillator signal from one of the one or more oscillator, wherein the oscillator signal is used for maintaining local clocks in the first and second node.

3. The method of claim 1, wherein obtaining first data related to the first sync pulse comprises:
obtaining first data comprising first metadata, d1, for the first sync pulse from the second node, and a pulse interval, pᵢᵥ, relating to a time interval between two consecutive sync pulses, and;
wherein obtaining second data related to the second sync pulse comprises:
obtaining, second data comprising second metadata, d2, for the second sync pulse from the second node,
wherein the first and second metadata comprise information of the sync pulse count for each respective sync pulse.

4. The method of claim 3, wherein estimating the time error, E, of the local clock of the first node comprises:
estimating the time error, E, as e2−e1, wherein e1 is the apparent elapsed time in the first node determined based on the timestamps as e1=t2−t1, and e2 is the apparent elapsed time in the second node determined based on the metadata and the pulse interval as e2=(d2−d1)*pᵢᵥ, wherein t1 is the timestamp and d1 is the metadata of the received first sync pulse before interruption of service of the first node.

5. The method of claim 1, wherein obtaining first data related to the first sync pulse comprises:
obtaining first data comprising an approximate absolute time, a1, relating to an approximate absolute time when the first sync pulse was received in the first node, and optionally a pulse interval, pᵢᵥ, relating to a time interval between two consecutive sync pulses, and;
wherein obtaining; second data related to the first sync pulse comprises:
obtaining, second data comprising an approximate absolute time, a2, relating to an approximate absolute time when the second sync pulse was received in the first node.

6. The method of claim 5, wherein estimating a time error, E, of the local clock of the first node comprises:
estimating the time error, E, as e2−e1, wherein e1 is the apparent elapsed time in the first node determined based on the timestamps as e1=t2−t1, and e2 is the apparent elapsed time in the second node determined based on the approximate absolute time (a2−a1) and rounded off to the closest multiple of the pulse interval pᵢᵥ as e2=round (a2−a1, pᵢᵥ), wherein t1 is the timestamp and a1 is the approximate absolute time of the received first sync pulse before interruption of service of the first node.

7. The method of claim 5, wherein the approximate absolute time is obtained from a battery backed real time clock, RTC, or a network time protocol, NTP, server.

8. The method of claim 1, wherein the obtaining first or second data includes receiving a separate transmission comprising the first or second data, or receiving the first or second data within each sync pulse transmission from the second node.

9. The method of claim 1, the method further comprising:
evaluating, in the first node, based the retrieved information and the second data, if an adjustment of a time of the local clock of the first node based on the second sync pulse and second data is possible; and
on condition that adjustment of a time of the local clock based on information relating to the second sync pulse is not possible;
adjusting the internal clock of the first node using a regular time
transfer or synchronization process.

10. The method of claim 9, wherein the first and second data comprises a first and second random token, which token is selected anew every time the second node restarts, and wherein evaluating, if an adjustment of the local clock of the first node based on the second sync pulse and second data is possible comprises:
comparing the first random token to the second random token; and
on condition that the first random token and the second random token are identical,
determining that adjustment of the local clock of the first node based on the second sync pulse and second data is possible; or
on condition that the first random token and the second random token are not identical,
determining that adjustment of the local clock of the first node based on the second sync pulse and second data is not possible.

11. The method of claim 2, wherein the oscillator signals received in the first and second node, respectively, are from a same frequency oscillator or from different frequency oscillators.

12. A system for enabling resumption of a time of a local clock in a first node after interruption of service of the first node, the system comprising:
the first node comprising the local clock, a communication interface and processing circuitry;
a second node, comprising a local clock, a communication interface and processing circuitry;
one or more frequency oscillator, each of the one or more oscillator being in connection with one or both of the first and second node, and
a memory;
wherein the system is configured to carry out the method according to claim 1.

13. The method of claim 1, wherein the interruption of service is due to a reset, restart or reboot of the first node.

14. The method of claim 1, wherein the first node comprises a field-programmable gate array, (FPGA).

15. The method or system according to claim 14, wherein the first node comprises a main FPGA, and the second node comprises a secondary FPGA.
